(19) United States
(12) Patent Application Publication
(10) Pub. No.: US 2013/0229365 A1
(43) Pub. Date: Sep. 5, 2013

(54) TOUCHPAD STRUCTURE AND MANUFACTURING METHOD THEREOF

(71) Applicants: Yu-Kai LIN, Hsinchu City (TW); Chien-Wen Tsai, Hsinchu County (TW); Ming-Lung Ho, Taoyuan County (TW)

(72) Inventors: Yu-Kai LIN, Hsinchu City (TW); Chien-Wen Tsai, Hsinchu County (TW); Ming-Lung Ho, Taoyuan County (TW)

(21) Appl. No.: 13/567,255

(22) Filed: Aug. 6, 2012

(30) Foreign Application Priority Data
Mar. 2, 2012 (TW) 101107104

(51) Int. Cl. G06F 3/041; H01H 11/00

(52) U.S. Cl. 345/173; 29/622

(57) ABSTRACT

A touchpad structure includes a substrate, a shielding layer and a sensing layer. The shielding layer fully covers a first surface of the substrate. By using a circuit forming process to form the sensing layer on the shielding layer so as to make the shielding layer sandwiched between the substrate and the sensing layer, the structural thickness and the manufacturing processes of the overall touchpad structure can be significantly reduced.

### FIELD OF THE INVENTION

The present invention is related generally to a touchpad structure and manufacturing method thereof and, more particularly, to a thinner touchpad structure with a sensing layer formed on the shielding layer by a circuit forming process for reducing manufacturing processes and a manufacturing method thereof.

### BACKGROUND OF THE INVENTION

Touchpads have been commonly used as an input interface for electronic devices. For example, touchpads embedded in laptops or touchpads connected to desktop PCs in a wired or wireless manner. Users can implement commands such as selecting, dragging and executing by the touchpads.

As shown in FIG. 1, a conventional touchpad structure 7 comprises a circuit board 71, a hard coat 72, an adhesive layer 73 and plural driving elements 74. The circuit board 71 is a printed circuit board (PCB), on which plural sensors and plural conducting wires connected to the sensors are laid. The hard coat 72 is a Mylar and adhered to one side of the circuit board 71 through the adhesive layer 73. The driving elements 74 are disposed at an opposite side of the circuit board 71 using surface mounting technology (SMT).

Since the conventional circuit board 71 is rigid, the adhesive layer 73 is necessary for affixing the hard coat 72 to the circuit board 71. During the adhering process, the layers have to be accurately aligned and appropriately stuck, so the operation of the adhering process is relatively difficult and the yield is relatively poor. In addition, for allowing the sensors that is directly formed on the circuit board 71 to detect touch gestures made on the hard coat 72, so the circuit board 71 has to be assembled to the side of the hard coat 72 in position, making the overall thickness of the conventional touchpad structure 7 be the sum of the respective thicknesses of the circuit board 71, the hard coat 72, the adhesive layer 73 and the driving elements 74. Moreover, the thicknesses of the circuit board 71 and the driving elements 74 can not significantly be reduced due to inherent layout requirements of the circuit board 71 and the driving elements 74, so the task of reducing the overall thickness of the conventional touchpad structure is difficult. Consequently, the target that is to lighten and to thin the touchpad can't be achieved.

Additionally, the Mylar that is used by the hard coat 72 does not provide good feel and in practice tends to hinder fingers from smoothly moving on the hard coat 72. It is adverse to smoothness and quality of the operation.

As shown in FIG. 2, another conventional touchpad structure 8 comprises a substrate 81, a sensing layer 82, an adhesive layer 83, a circuit board 84 and plural driving elements 85. The substrate 81 is a glass substrate and the sensing layer 82 has a sensing circuit structure which is directly forming on a thin film by printing manner. The sensing layer 82 is affixed to one side of the substrate 81 through an adhesive layer 83, and one end of the circuit board 84 is electrically connected to the sensing layer 82, while the driving elements 85 are mounted on one side of the circuit board 84.

Although the conventional touchpad structure 8 uses glass to replace the Mylar of the conventional touchpad structure 7 and thereby improves feel, its substrate 81 is also rigid so the sensing layer 82 also has to be affixed to the side of the substrate 81 using the adhesive layer 83. Thus, the problems about difficult operation of adhering process and poor yield caused by using the adhesive layer 73 or 83 remain unsolved.

The conventional one glass solutions (OGS) are mainly used in electronic touch devices, such as smart mobile phones and iPads. As shown in FIG. 3, a conventional OGS 9 comprises a substrate 91, an ink layer 92, a covering layer 93, a sensing layer 94 and a circuit board 95. The substrate 91 is a glass substrate and the ink layer 92 is arranged along a periphery of one surface of the substrate 91, so that the central area of the substrate 91 is left as an area that can be seen through. The covering layer 93 is transparent and laid on the surface of the substrate 91 on which the ink layer 92 is arranged so as to fully cover the substrate 91 and the ink layer 92. The sensing layer 94 is formed on a surface of the covering layer 93 by a thin film forming process, and one end of the circuit board 95 is electrically connected to the sensing layer 94.

Comparing the conventional touchpad structures 7 and 8, although OGS 9 eliminates the problems coming from the adhesive layer 73 or 83, its application field is different from that of the conventional touchpad structures 7 and 8 in nature. Furthermore, due to the seeing-through area formed in the central area of conventional OGS 9, the ink layer 92 on the surface of the substrate 91 forms a thickness drop. The surface of the substrate 91 having the ink layer 92 is not even, so the covering layer 93 has to be added to cover the surfaces of the substrate 91 and the ink layer 92 in order to provide an even plane that allows the sensing layer 94 to be laid evenly and uniformly on the side of the substrate 91. Consequently, the manufacturing process of the conventional OGS 9 is very complicated. In addition, for allowing users to see images through the seeing-through area, the sensing layer 94 in the OGS 9 can only be made of transparent metallic material.

### SUMMARY OF THE INVENTION

An objective of the present invention is to provide a touchpad structure, wherein a sensing layer is formed on a shielding layer using a circuit forming process, so that the overall thickness of the touchpad structure can be reduced.

Another objective of the present invention is to provide a manufacturing method of a touchpad structure, wherein a sensing layer is formed on a shielding layer using a circuit forming process, so that the manufacturing process can be simplified and the yield can be improved.

According to the present invention, a touchpad structure comprises a substrate, a shielding layer and a sensing layer, wherein the substrate has a first surface fully covered by the shielding layer, and the sensing layer is formed on one side of the shielding layer, so that the shielding layer is sandwiched between the substrate and the sensing layer.

According to the present invention, a touchpad structure comprises a substrate, a shielding layer and a sensing layer, wherein the substrate has a first surface and the shielding layer covers the first surface of the substrate. The sensing layer is formed on one side of the shielding layer by a circuit forming process, so that the shielding layer is sandwiched between the substrate and the sensing layer.

According to the present invention, a manufacturing method of a touchpad structure comprises providing a substrate, forming a shielding layer on a first surface of the substrate, and forming a sensing layer on the shielding layer by a circuit forming process.

### BRIEF DESCRIPTION OF THE DRAWINGS

These and other objectives, features and advantages of the present invention will become apparent to those skilled in the art upon consideration of the following description of the preferred embodiments according to the present invention taken in conjunction with the accompanying drawings, in which:

FIG. 1 is a cross-sectional view of a conventional touchpad structure;

FIG. 2 is a cross-sectional view of another conventional touchpad structure;

FIG. 3 is a cross-sectional view of a conventional OGS;

FIG. 4 is a cross-sectional view of a touchpad structure according to one preferred embodiment of the present invention;

FIG. 5 is a bottom view of a sensing layer according to the preferred embodiment of the present invention;

FIG. 6 is a bottom view of another embodiment of the sensing layer according to the preferred embodiment of the present invention;

FIG. 7 is a flow chart of a manufacturing method according to the preferred embodiment of the present invention;

FIG. 8 is a cross-sectional view of a part of the sensing layer circled by a dotted circle in FIG. 5;

FIG. 9 is a cross-sectional view of another embodiment of the sensing layer circled by a dotted circle in FIG. 5; and

FIG. 10 shows a circuit component according to the preferred embodiment of the present invention connected to the sensing layer through a flexible flat cable.

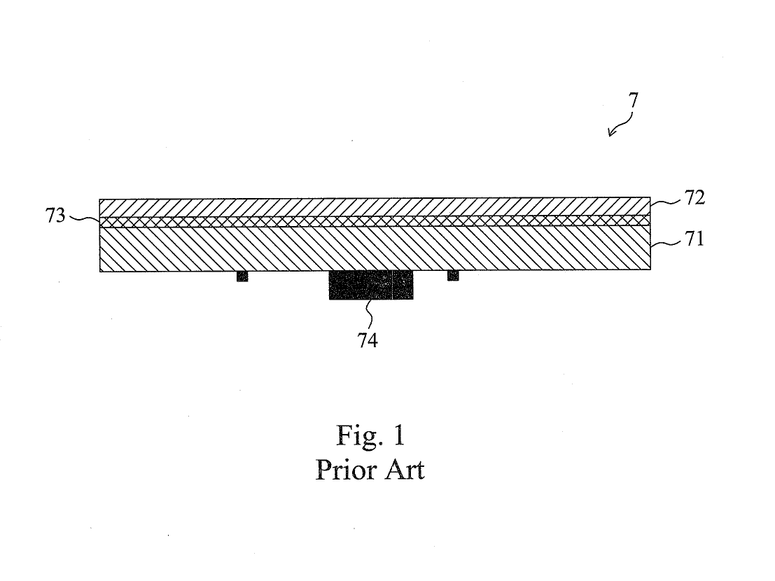

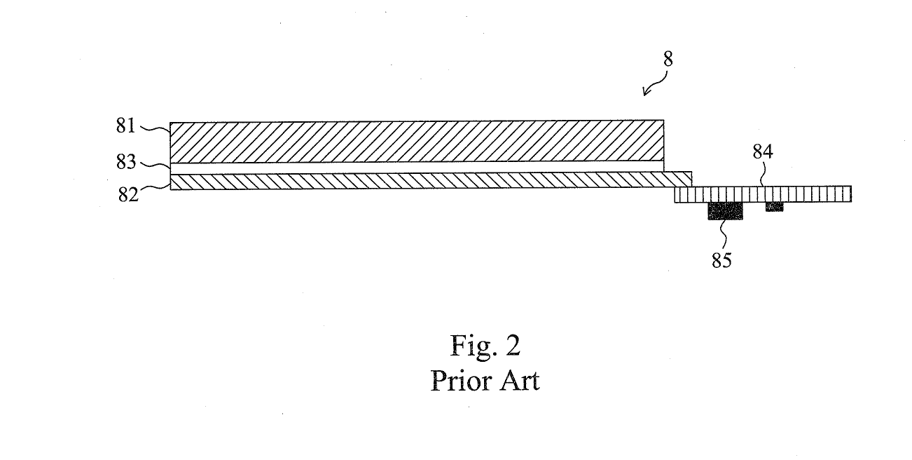

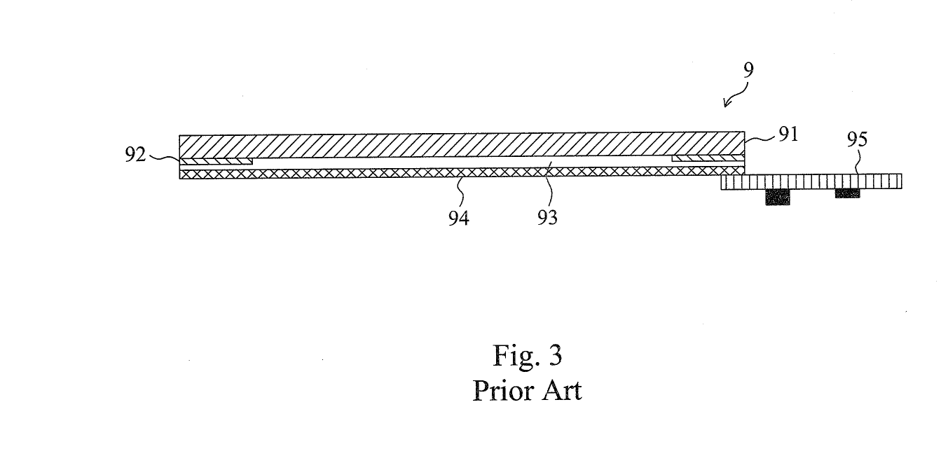

### DETAILED DESCRIPTION OF THE INVENTION

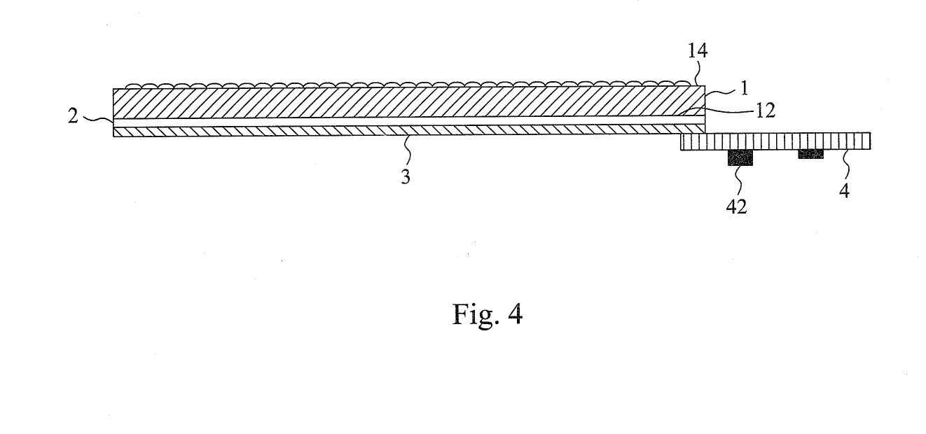

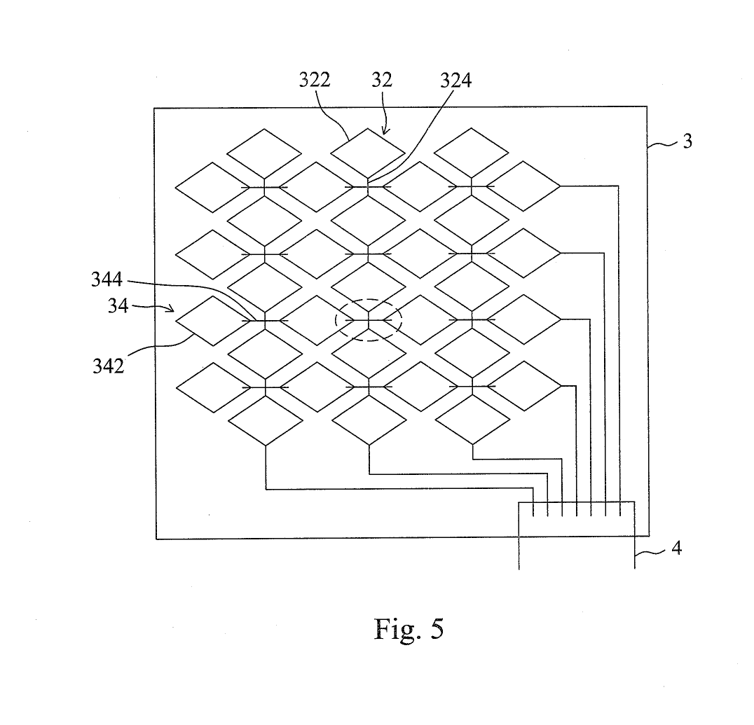

Referring to FIG. 4 and FIG. 5, in a preferred embodiment according to the present invention, a touchpad structure comprises a substrate 1, a shielding layer 2, a sensing layer 3 and a circuit component 4. The substrate 1 is preferably a glass substrate. Two opposite surfaces of the substrate 1 are defined as a first surface 12 and a second surface 14, respectively. The shielding layer 2 is formed on and fully covers the first surface 12. The second surface 14 acts as an operative surface on which a user can operate by an object, e.g. a finger or a touch pen, to control a cursor or input commands.

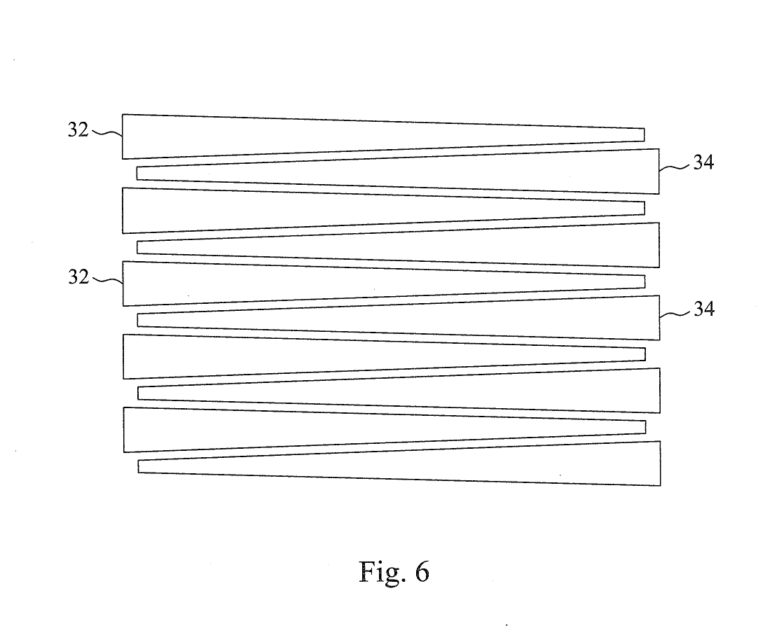

FIG. 5 is a bottom view of the sensing layer 3 of the touchpad structure according to the present invention. The sensing layer 3 has a sensing circuit structure directly formed on the shielding layer 2 for detecting touch gestures performed on the substrate 1 and generating sensing signals accordingly. The sensing circuit structure comprises plural first direction traces 32 and plural second direction traces 34. The first direction trace 32 has plural first direction sensors 322 and plural conducting wires 324, wherein the conducting wires 324 are electrically connected to the first direction sensors 322. The second direction trace 34 has plural second direction sensors 342 and plural conductive bridges 344. The conductive bridge 344 cross the conducting wire 324 of the first direction traces 32 and are electrically connected to the second direction sensors 342. In this embodiment, the first and second direction traces 32, 34 are orthographically arranged but may be arranged otherwise in other embodiments. In practical use, as shown in FIG. 6, the first and second direction traces 32, 34 may be arranged in interlaced and parallel or any other feasible circuit layouts.

The circuit component 4 may be a PCB or a flexible printed circuit board (FPC) according to practical needs. The circuit component 4 is electrically connected to the sensing layer 3 and has a driving element 42. The circuit component 4 receives the sensing signals from the sensing layer 3 and uses the driving element 42 to drive the electronic device to perform corresponding commands.

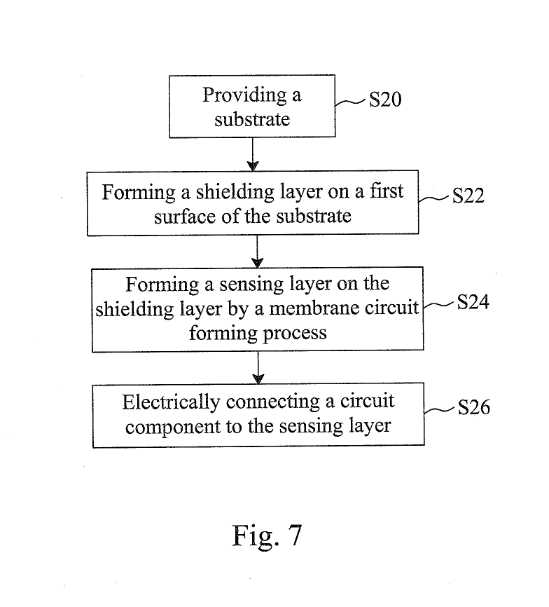

FIG. 7 illustrates a manufacturing method of the foregoing touchpad structure. In a step S20, a substrate 1 is provided. Further, in the step S20, the substrate 1 may be selectively proceeded at least one pre-treatment process, such as surface roughening (fogging) treatment, strengthening treatment or grinding and polishing treatment. For example, in this embodiment, the second surface 14 of the substrate 1 is fogged by etching or sandblasting in advance, so as to allow users' fingers to operate on the second surface 14 with better feel and smoothness. Afterward, the substrate 1 proceeds strengthening treatment so as to improved structural strength oneself. In a step S22, a shielding layer 2 is formed on the first surface 12 of the substrate 1. In this embodiment, the method for forming the shielding layer 2 is transferring ink to the first surface 12 by a printing manner. Alternatively, the shielding layer 2 may be formed as a metal layer on the first surface 12 by a vapor deposition process, such as sputtering or evaporation, depending on the material requirement. Preferably, the shielding layer 2 is an opaque or semi-opaque layer fully covering the first surface 12. The shielding layer 2 may have a primary color that matches the hues of the electronic product so as to improve the elegance and visual effects of the product.

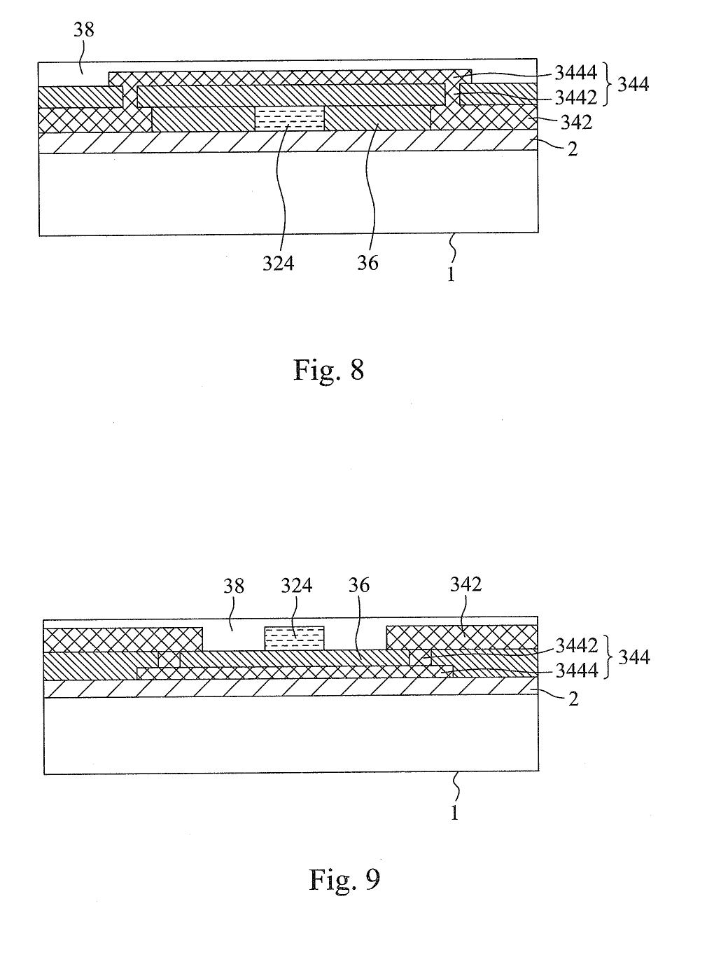

FIG. 8 is a partial cross-sectional view of the part circled by a dotted circle of sensing layer 3 in FIG. 5. For the convenience of illustrating the formation of the sensing layer 3, the substrate 1 is placed at the bottommost level in FIG. 8. In a step S24, the sensing layer 3 is formed on the shielding layer 2 by a circuit forming process. According to requirement, the circuit forming process may be the thin film process, including a process combination of the vapor deposition and the lithography or a process combination of the vapor deposition and the laser, or the printing circuit process. In this embodiment, the sensing layer 3 is formed by a thin film process. First, the first direction sensors 322, conducting wires 324 and the second direction sensors 342 are formed on the shielding layer 2 using vapor deposition and lithography processes, and then an isolation layer 36 is formed to cover the first direction sensors 322, the conducting wires 324 and the second direction sensor 342. The isolation layer 36 is etched to partially expose the second direction sensors 342. Conductive poles 3442 are formed on the exposed parts of the second direction sensors 342, and conductive plates 3444 are formed on the isolation layer 36. The conductive poles 3442 and the conductive plates 3444 are mutually connected and form conductive bridges 344 that span the conducting wires 324 to make the adjacent second direction sensors 342 electrically connected with each other, thereby forming the second direction traces 34. At last, the hard coat 38 is formed to cover the conductive bridges 344 and the isolation layers 36. Preferably, the hard coat 38 is made of isolation material.

FIG. 8 shows one sensing circuit structure of the sensing layer 3 formed on the shielding layer 2 by the thin film forming process, and FIG. 9 discloses an alternative sensing circuit structure of the sensing layer 3. In another embodiment, the conductive plates 3444 are first formed on the shielding layer 2 directly, and then the isolation layer 36 is formed to cover the conductive plates 3444. Afterward, the isolation layer 36 is etched to partially expose the conductive plates 3444, and then the conductive poles 3442 are formed at where the conductive plates 3444 are exposed such that the conductive poles 3442 and the conductive plates 3444 are connected mutually to form the conductive bridges 344. Subsequently, by vapor deposition and etching processes, the first direction sensors 322, the conducting wires 324 and the second direction sensor 342 are formed on the conductive poles 3442 and the isolation layer 36. The adjacent second direction sensors 342 are electrically connected to each other through the conductive bridges 344. At last, the hard coat 38 is formed to cover the first direction sensors 322, the conducting wires 324, the second direction sensors 342 and the isolation layer 36.

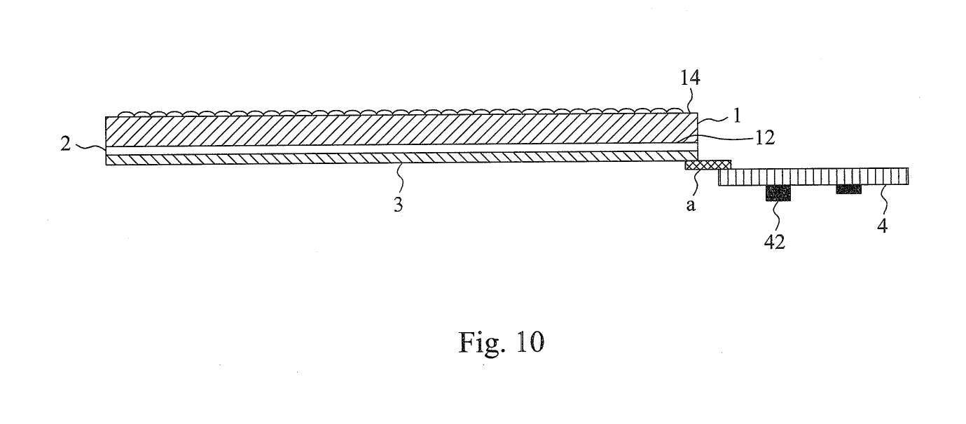

Referring to FIG. 4 and FIG. 10, in a step S26, the circuit component 4 is electrically connected to the sensing layer 3. If the circuit component 4 is a printed circuit board, the circuit component 4 is connected to the sensing layer 3 through a flexible flat cable (FFC) a. If the circuit component 4 is a flexible printed circuit board, one end of the circuit component 4 may be directly electrically connected to the sensing layer 3.

By forming the sensing layer 3 directly on a relatively thin shielding layer 2, the present invention eliminates the use of an adhesive layer used in the conventional touchpad structures and eliminates the use of a covering layer used in the conventional OGS, thus significantly reducing the overall thickness of the touchpad structure. In addition, since there is no use of any adhesive or covering layers, the present invention can effectively improve yield because the difficult adhering process between layers and the additional procedures for evening are both eliminated from the practical manufacturing process.

Also, since the shielding layer 2 of the present invention is opaque or semi-opaque and fully covers the first surface 12 of the substrate 1 so as to completely or partially block users' line of sight, users can not see the sensing layer 3 clearly through the substrate 1, so the material color of the sensing layer 3 are non-limitation. The sensing layer 3 can be transparent or non-transparent. The first and second direction traces 32, 34 may be made of transparent electric conductivity material, such as ITO, or may be made of low-impedance non-transparent electric conductivity material, such as gold, silver, copper, nano silver, grapheme and carbon nanotubes.

Moreover, since the shielding layer 2 of the present invention fully covers the first surface 12 of the substrate 1, there is no need to perform additional surface evening treatment for the first surface 12, and the sensing layer 3 can be directly formed on the shielding layer 2. Thereby, the present invention is contributive to simplifying the manufacturing process.

While the present invention has been described in conjunction with preferred embodiments thereof, it is evident that many alternatives, modifications and variations will be apparent to those skilled in the art. Accordingly, it is intended to embrace all such alternatives, modifications and variations that fall within the spirit and scope thereof as set forth in the appended claims.

What is claimed is:

1. A touchpad structure comprising:
a substrate having a first surface;
a shielding layer fully covering the first surface of the substrate; and
a sensing layer being formed on one side of the shielding layer so that the shielding layer is sandwiched between the substrate and the sensing layer.

2. The touchpad structure of claim 1, wherein the shielding layer is opaque or semi-opaque.

3. The touchpad structure of claim 1, wherein the substrate further has a second surface opposite to the first surface and the second surface is a roughed surface.

4. The touchpad structure of claim 1, wherein the sensing layer comprises plural first direction traces, and each said first direction trace has first direction sensors and conducting wires, in which the conducting wires are connected to the first direction sensors.

5. The touchpad structure of claim 4, wherein the sensing layer further comprises plural second direction traces, and each said second direction traces has second direction sensors and conductive bridges, in which the conductive bridge span the conducting wires of the first direction traces and are electrically connected to the second direction sensors.

6. The touchpad structure of claim 5, wherein the first and second direction traces are made of a transparent electric conductivity material which is ITO.

7. The touchpad structure of claim 5, wherein the first and second direction traces are made of a non-transparent electric conductivity material which is gold, silver, copper, nano silver, graphene or carbon nanotubes.

8. The touchpad structure of claim 4, wherein the first direction traces of the sensing layer are directly formed on the side of the shielding layer.

9. The touchpad structure of claim 5, wherein the first and second direction traces of the sensing layer are directly formed on the side of the shielding layer.

10. The touchpad structure of claim 5, wherein the sensing layer has a hard coat covering outside surfaces of the first and second direction traces.

11. The touchpad structure of claim 1, further comprising a circuit component electrically connected to the sensing layer.

12. The touchpad structure of claim 11, wherein the circuit component is a printed circuit board or a flexible printed circuit board.

13. A touchpad structure comprising:
a substrate having a first surface;
a shielding layer on the first surface of the substrate;
a sensing layer being capable of detecting touch gestures performed on the substrate and generating sensing signals accordingly, and the sensing layer being formed on one side of the shielding layer so that the shielding layer is sandwiched between the substrate and the sensing layer.

14. The touchpad structure of claim 13, wherein the shielding layer is opaque or semi-opaque, and fully covers the first surface of the substrate.

15. The touchpad structure of claim 13, wherein the sensing layer is formed on the side of the shielding layer by a thin film process or a printing circuit process.

16. The touchpad structure of claim 13, wherein the substrate further has a second surface opposite to the first surface and the second surface is a roughed surface.

17. The touchpad structure of claim 13, wherein the sensing layer comprises plural first direction traces, and each said first direction trace has first direction sensors and conducting wires, in which the conducting wires are connected to the first direction sensors.

18. The touchpad structure of claim 17, wherein the sensing layer further comprises plural second direction traces, and each said second direction traces has second direction sensors and conductive bridges, in which the conductive bridge span the conducting wires of the first direction traces and are electrically connected to the second direction sensors.

19. The touchpad structure of claim 18, wherein the first and second direction traces are made of a transparent electric conductivity material which is ITO.

20. The touchpad structure of claim 18, wherein the first and second direction traces are made of a non-transparent electric conductivity material which is gold, silver, copper, nano silver, graphene or carbon nanotubes.

21. The touchpad structure of claim 17, wherein the first direction traces of the sensing layer are directly formed on the side of the shielding layer.

22. The touchpad structure of claim 18, wherein the first and second direction traces of the sensing layer are directly formed on the side of the shielding layer.

23. The touchpad structure of claim 18, wherein the sensing layer has a hard coat covering the first and second direction traces.

24. The touchpad structure of claim 13, further comprising a circuit component electrically connected to the sensing layer.

25. The touchpad structure of claim 24, wherein the circuit component is a printed circuit board or a flexible printed circuit board.

26. A manufacturing method of a touchpad structure, comprising steps of:
providing a substrate;
forming a shielding layer on a first surface of the substrate so as to fully cover the first surface; and
forming a sensing layer on the shielding layer.

27. The manufacturing method of claim 26, wherein the step of the forming a sensing layer comprises forming the sensing layer on the shielding layer by a non-adhering process.

28. The manufacturing method of claim 26, wherein the step of the forming a sensing layer comprises forming the sensing layer on the shielding layer by a thin film process or a printing circuit process.

29. The manufacturing method of claim 26, further comprising performing a surface roughing treatment to the first surface of the substrate.

30. The manufacturing method of claim 26, wherein the step of the forming the shielding layer comprises transferring ink to the first surface by a printing manner so as to fog in an ink layer as the shielding layer.

31. The manufacturing method of claim 26, wherein the step of the forming the shielding layer comprises forming a metal layer on the first surface by a vapor deposition process as the shielding layer.

32. The manufacturing method of claim 26, further comprising electrically connecting a circuit component to the sensing layer.

33. The manufacturing method of claim 26, further comprising when the sensing layer is formed on the shielding layer, forming a hard coat over the sensing layer.

34. A touchpad structure made using the manufacturing method of claim 26, the touchpad structure comprising:
a substrate having a first surface;
a shielding layer fully covering the first surface of the substrate; and
a sensing layer being capable of detecting touch gestures performed on the substrate and generating sensing signals accordingly, and the sensing layer being formed on one side of the shielding layer so that the shielding layer is sandwiched between the substrate and the sensing layer.
